(19) United States
(12) Patent Application Publication
(10) Pub. No.: US 2020/0097301 A1
(43) Pub. Date: Mar. 26, 2020

(54) PREDICTING RELEVANCE USING NEURAL NETWORKS TO DYNAMICALLY UPDATE A USER INTERFACE

(71) Applicant: Optum, Inc., Minnetonka, MN (US)

(72) Inventors: Somadev Pasala, Minnetonka, MN (US); Jose A. Mendes, Minnetonka, MN (US); Alex J. Hill, Minnetonka, MN (US); Nicholas Leong, Minnetonka, MN (US); Marie Babic, Minnetonka, MN (US); Mihir Patel, Minnetonka, MN (US)

(21) Appl. No.: 16/136,465

(22) Filed: Sep. 20, 2018

(51) Int. Cl. G06F 9/451; G06F 8/65; G06N 3/08

(52) U.S. Cl. CPC G06F 9/451; G06N 3/08; G06F 8/65

(57) ABSTRACT

Methods, apparatus, systems, computing devices, computing entities, and/or the like for using machine-learning concepts (e.g., neural networks) to determine predicted relevancy scores for transactions, sort the transactions based on the same, and generate and provide a user interface based at least in part on the scores for presentation to an end user.

### TECHNOLOGICAL FIELD

Embodiments of the present invention generally relate to machine-learning based methodologies for automatic predictions of relevancy scores indicative of the predicted level of interest to a stakeholder (e.g., person or entity) and dynamic updates for a user interface regarding the same.

### BACKGROUND

Annually, there are countless transactions that occur that relate to one or more stakeholders (e.g., persons or entities). For example, in the healthcare context, there are more than 10 billion healthcare-related claims (e.g., transactions) that are submitted and processed in the United States each year. Current methodologies for predicting the relevance of each transaction and presenting the same to end users are inaccurate, inefficient, and resource-intensive. For instance, in the healthcare context, searching and ranking these claims (e.g., by date, by name, by procedure, etc.) is inefficient and affects all aspects of health insurance companies.

Accordingly, there is a latent need for a rigorous methodology that can automatically predict relevancy scores indicative of the predicted level of interest to a stakeholder (e.g., person or entity) and dynamically update a user interface regarding the same. Through applied effort, ingenuity, and innovation, the inventors have developed systems and methods that produce such predictions, scores, and dynamic interface updates. Some examples of these solutions are described in detail herein.

### BRIEF SUMMARY

In general, embodiments of the present invention provide methods, apparatus, systems, computing devices, computing entities, and/or the like.

In accordance with one aspect, a method is provided. In one embodiment, the method comprises storing a communication record corresponding to a communication for a first transaction, the first communication record comprising first communication data; storing an indication with a first transaction record for the first transaction, the indication indicating that a first communication has occurred for the first transaction, the first transaction record comprising first transaction data; aggregating a set of training data to train one or more artificial neural networks, the training data comprising at least a portion of the first communication data and at least a portion of the first communication data; after training the neural network, receiving a second transaction record, the second transaction record corresponding to a second transaction and comprising second transaction data; determining a first predicted relevancy score for the second transaction record using the one or more artificial neural networks, the first predicted relevancy score indicative of the predicted relevance to a first user; determining a second predicted relevancy score for the second transaction record using the one or more artificial neural networks, the second predicted relevancy score indicative of the predicted relevance to a second user; storing the first predicted relevancy score and the second predicted relevancy score in a data structure; and dynamically providing a user interface for display of at least a portion of the second transaction data in association with the first predicted relevancy score or the second predicted relevancy score.

In accordance with another aspect, a computer program product is provided. The computer program product may comprise at least one computer-readable storage medium having computer-readable program code portions stored therein, the computer-readable program code portions comprising executable portions configured to store a communication record corresponding to a communication for a first transaction, the first communication record comprising first communication data; store an indication with a first transaction record for the first transaction, the indication indicating that a first communication has occurred for the first transaction, the first transaction record comprising first transaction data; aggregate a set of training data to train one or more artificial neural networks, the training data comprising at least a portion of the first communication data and at least a portion of the first communication data; after training the neural network, receive a second transaction record, the second transaction record corresponding to a second transaction and comprising second transaction data; determine a first predicted relevancy score for the second transaction record using the one or more artificial neural networks, the first predicted relevancy score indicative of the predicted relevance to a first user; determine a second predicted relevancy score for the second transaction record using the one or more artificial neural networks, the second predicted relevancy score indicative of the predicted relevance to a second user; store the first predicted relevancy score and the second predicted relevancy score in a data structure; and dynamically provide a user interface for display of at least a portion of the second transaction data in association with the first predicted relevancy score or the second predicted relevancy score.

In accordance with yet another aspect, a computing system comprising at least one processor and at least one memory including computer program code is provided. In one embodiment, the at least one memory and the computer program code may be configured to, with the processor, cause the apparatus to store a communication record corresponding to a communication for a first transaction, the first communication record comprising first communication data; store an indication with a first transaction record for the first transaction, the indication indicating that a first communication has occurred for the first transaction, the first transaction record comprising first transaction data; aggregate a set of training data to train one or more artificial neural networks, the training data comprising at least a portion of the first communication data and at least a portion of the first communication data; after training the neural network, receive a second transaction record, the second transaction record corresponding to a second transaction and comprising second transaction data; determine a first predicted relevancy score for the second transaction record using the one or more artificial neural networks, the first predicted relevancy score indicative of the predicted relevance to a first user; determine a second predicted relevancy score for the second transaction record using the one or more artificial neural networks, the second predicted relevancy score indicative of the predicted relevance to a second user; store the first predicted relevancy score and the second predicted relevancy score in a data structure; and dynamically provide a user interface for display of at least a portion of the second transaction data in association with the first predicted relevancy score or the second predicted relevancy score.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a diagram of a relevancy prediction system that can be used in conjunction with various embodiments of the present invention;

FIG. 2A is a schematic of an analytic computing entity in accordance with certain embodiments of the present invention;

FIG. 2B is a schematic representation of a memory media storing a plurality of repositories, databases, data stores, and/or relational tables;

FIG. 3 is a schematic of a user computing entity in accordance with certain embodiments of the present invention;

FIG. 4 is an example process of training and predicting using a neural network in accordance with certain embodiments of the present invention;

FIGS. 5A, 5B, 5C, and 5D are example of features for training a neural network or generating predicted relevancy score using a neural network in accordance with certain embodiments of the present invention;

FIG. 6 is an exemplary data structure storing predicted relevancy score information/data corresponding to a particular transaction in accordance with certain embodiments of the present invention;

FIG. 7 is an exemplary neural network for generating predicted relevancy score in accordance with certain embodiments of the present invention;

FIGS. 8A, 8B, and 8C are flowcharts for exemplary operations, steps, and processes in accordance with certain embodiments of the present invention; and

FIG. 9 provides and an interactive user interface dynamically updated based at least in part on predicted relevancy scores in accordance with embodiments of the present invention.

### DETAILED DESCRIPTION OF SOME EXAMPLE EMBODIMENTS

Various embodiments of the present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” (also designated as “/”) is used herein in both the alternative and conjunctive sense, unless otherwise indicated. The terms “illustrative” and “exemplary” are used to be examples with no indication of quality level. Like numbers refer to like elements throughout.

### I. COMPUTER PROGRAM PRODUCTS, METHODS, AND COMPUTING ENTITIES

Embodiments of the present invention may be implemented in various ways, including as computer program products that comprise articles of manufacture. Such computer program products may include one or more software components including, for example, software objects, methods, data structures, and/or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like. As such, embodiments of the present invention may take the form of a data structure, apparatus, system, computing device, computing entity, and/or the like executing instructions stored on a computer-readable storage medium to perform certain steps or operations. Thus, embodiments of the present invention may also take the form of an entirely hardware embodiment, an entirely computer program product embodiment, and/or an embodiment that comprises combination of computer program products and hardware performing certain steps or operations.

Embodiments of the present invention are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### II. EXEMPLARY SYSTEM ARCHITECTURE

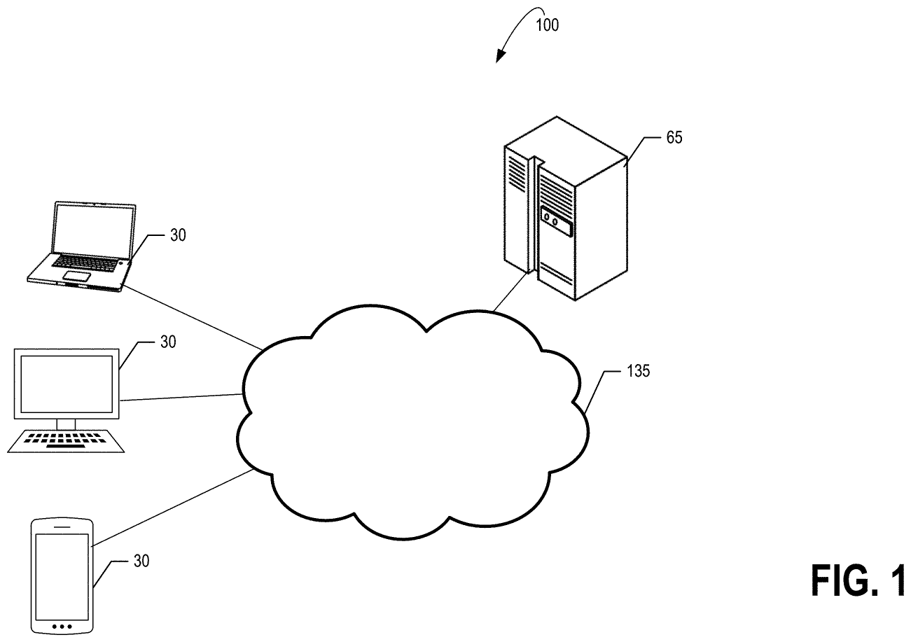

FIG. 1 provides an illustration of a relevancy prediction system 100 that can be used in conjunction with various embodiments of the present invention. As shown in FIG. 1, the relevancy prediction system 100 may comprise one or more analytic computing entities 65, one or more user computing entities 30, one or more networks 135, and/or the like. Each of the components of the system may be in electronic communication with, for example, one another over the same or different wireless or wired networks 135 including, for example, a wired or wireless Personal Area Network (PAN), Local Area Network (LAN), Metropolitan Area Network (MAN), Wide Area Network (WAN), and/or the like. Additionally, while FIG. 1 illustrate certain system entities as separate, standalone entities, the various embodiments are not limited to this particular architecture.

a. Exemplary Analytic Computing Entity

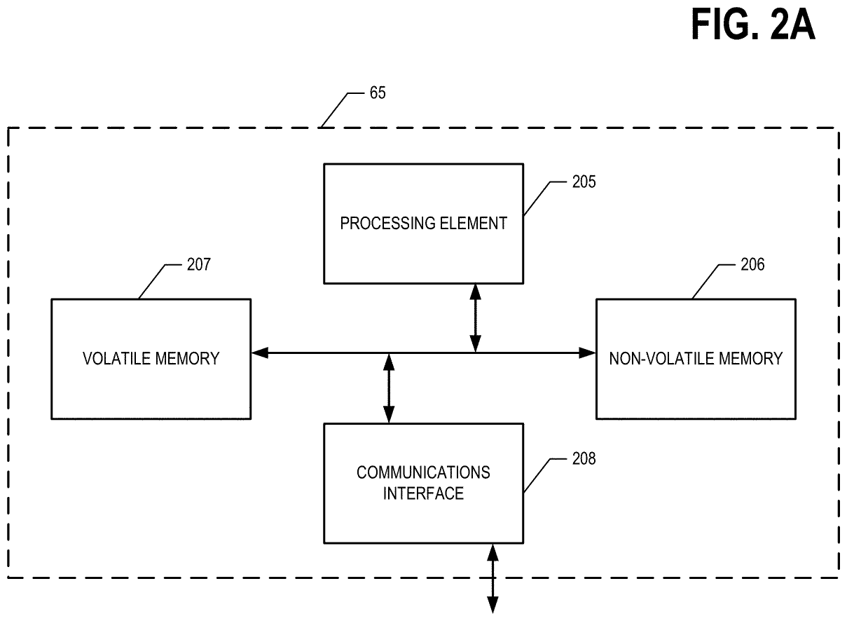

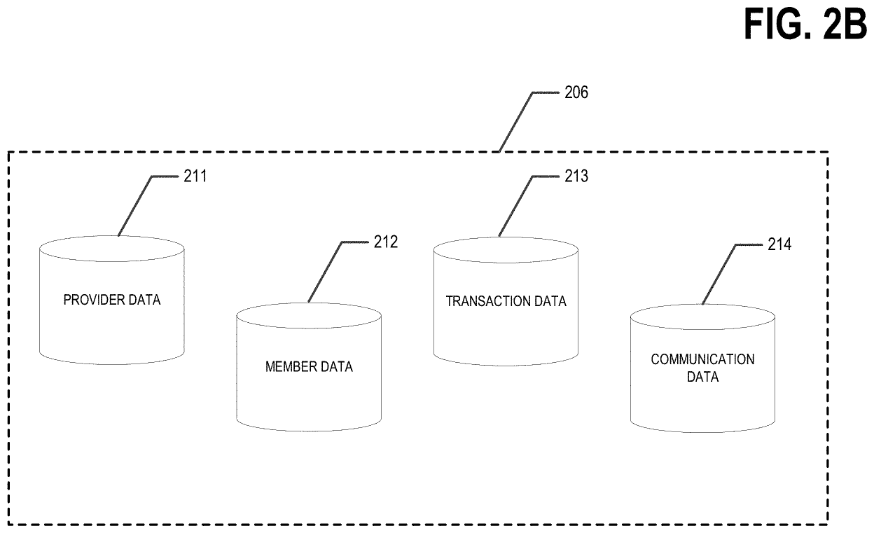

FIG. 2A provides a schematic of an analytic computing entity 65 according to one embodiment of the present invention. In general, the terms computing entity, entity, device, system, and/or similar words used herein interchangeably may refer to, for example, one or more computers, computing entities, desktop computers, mobile phones, tablets, phablets, notebooks, laptops, distributed systems, items/devices, terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

As indicated, in one embodiment, the analytic computing entity 65 may also include one or more network and/or communications interfaces 208 for communicating with various computing entities, such as by communicating data, content, information, and/or similar terms used herein interchangeably that can be transmitted, received, operated on, processed, displayed, stored, and/or the like. For instance, the analytic computing entity 65 may communicate with other computing entities 65, one or more user computing entities 30, and/or the like.

As shown in FIG. 2A, in one embodiment, the analytic computing entity 65 may include or be in communication with one or more processing elements 205 (also referred to as processors, processing circuitry, and/or similar terms used herein interchangeably) that communicate with other elements within the analytic computing entity 65 via a bus, for example, or network connection. As will be understood, the processing element 205 may be embodied in a number of different ways. For example, the processing element 205 may be embodied as one or more complex programmable logic devices (CPLDs), microprocessors, multi-core processors, coprocessing entities, application-specific instruction-set processors (ASIPs), and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present invention when configured accordingly.

In one embodiment, the analytic computing entity 65 may further include or be in communication with non-volatile media (also referred to as non-volatile storage, memory, memory storage, memory circuitry and/or similar terms used herein interchangeably). In one embodiment, the non-volatile storage or memory may include one or more non-volatile storage or memory media 206 as described above, such as hard disks, ROM, PROM, EPROM, EEPROM, flash memory, MMCs, SD memory cards, Memory Sticks, CBRAM, PRAM, FeRAM, RRAM, SONOS, racetrack memory, and/or the like. As will be recognized, the non-volatile storage or memory media may store databases, database instances, database management system entities, data, applications, programs, program modules, scripts, source code, object code, byte code, compiled code, interpreted code, machine code, executable instructions, and/or the like. The term database, database instance, database management system entity, and/or similar terms used herein interchangeably and in a general sense to refer to a structured or unstructured collection of information/data that is stored in a computer-readable storage medium.

Memory media 206 may also be embodied as a data storage device or devices, as a separate database server or servers, or as a combination of data storage devices and separate database servers. Further, in some embodiments, memory media 206 may be embodied as a distributed repository such that some of the stored information/data is stored centrally in a location within the system and other information/data is stored in one or more remote locations. Alternatively, in some embodiments, the distributed repository may be distributed over a plurality of remote storage locations only. An example of the embodiments contemplated herein would include a cloud data storage system maintained by a third party provider and where some or all of the information/data required for the operation of the relevancy prediction system may be stored. As a person of ordinary skill in the art would recognize, the information/data required for the operation of the relevancy prediction system may also be partially stored in the cloud data storage system and partially stored in a locally maintained data storage system.

Memory media 206 may include information/data accessed and stored by the relevancy prediction system to facilitate the operations of the system. More specifically, memory media 206 may encompass one or more data stores configured to store information/data usable in certain embodiments. For example, as shown in FIG. 2B, data stores encompassed within the memory media 206 may comprise provider information/data 211, member information/data 212, transaction information/data 213, communication information/data 214, and/or the like.

As illustrated in FIG. 2B, the data stores 206 may comprise provider information/data 211 having identifying information/data indicative of various providers. The term provider is used generally to refer to any person or entity that provides goods, services, and/or the like. For example, the provider information/data 211 may comprise provider identifiers, provider locations, provider relevancy scores, and/or the like. The provider information/data may further comprise provider flag information/data providing an indicator conveying that the provider is involved in an ongoing investigation or may need the provider's claims flagged for overpayment or fraud review.

Continuing with FIG. 2B, the data stores 206 may comprise member information/data 212. The member information/data 212 may comprise information/data for a member, such as age, gender, poverty rates, known health conditions, home location, profession, access to medical care, medical history, claim history, member identifier (ID), and/or the like. A relevancy score may identify the predicted level of interest or relevance to the member.

Continuing with FIG. 2B, transaction information/data may comprise claim information/data 213 indicative of claims filed on behalf of a provider for services or products. Examples of providers include medical doctors, nurse practitioners, physician assistants, nurses, other medical professionals practicing in one or more of a plurality of medical specialties (e.g., psychiatry, pain management, anesthesiology, general surgery, emergency medicine, etc.), hospitals, urgent care centers, diagnostic laboratories, surgery centers, and/or the like. Moreover, the claim information/data 213 may further comprise prescription claim information/data. Prescription claim information/data may be used to extract information/data such as the identity of entities that prescribe certain drugs and the pharmacies who fulfill such prescriptions. The claim information/data 213 may also comprise communication flag information/data indicative of whether there are one or more communication logs associated with the claim.

The data stores 206 may further store communication information/data 214 used by the relevancy prediction system. For example, the communication information/data 212 stored by the data store may comprise the type of communication, the transaction (e.g., claim) to which it relates, the date of the communication, the time of the communication, the user (e.g., provider, member, insurance company) associated with the communication, and/or the like.

In one embodiment, the analytic computing entity 65 may further include or be in communication with volatile media (also referred to as volatile storage, memory, memory storage, memory circuitry and/or similar terms used herein interchangeably). In one embodiment, the volatile storage or memory may also include one or more volatile storage or memory media 207 as described above, such as RAM, DRAM, SRAM, FPM DRAM, EDO DRAM, SDRAM, DDR SDRAM, DDR2 SDRAM, DDR3 SDRAM, RDRAM, VRAM, cache memory, register memory, and/or the like. As will be recognized, the volatile storage or memory media may be used to store at least portions of the databases, database instances, database management system entities, data, applications, programs, program modules, scripts, source code, object code, byte code, compiled code, interpreted code, machine code, executable instructions, and/or the like being executed by, for example, the processing element 308. Thus, the databases, database instances, database management system entities, data, applications, programs, program modules, scripts, source code, object code, byte code, compiled code, interpreted code, machine code, executable instructions, and/or the like may be used to control certain aspects of the operation of the analytic computing entity 65 with the assistance of the processing element 205 and operating system.

As indicated, in one embodiment, the analytic computing entity 65 may also include one or more network and/or communications interfaces 208 for communicating with various computing entities, such as by communicating data, content, information, and/or similar terms used herein interchangeably that can be transmitted, received, operated on, processed, displayed, stored, and/or the like. For instance, the analytic computing entity 65 may communicate with computing entities or communication interfaces of other computing entities 65, user computing entities 30, and/or the like.

As indicated, in one embodiment, the analytic computing entity 65 may also include one or more network and/or communications interfaces 208 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the analytic computing entity 65 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The analytic computing entity 65 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

As will be appreciated, one or more of the analytic computing entity's components may be located remotely from other analytic computing entity 65 components, such as in a distributed system. Furthermore, one or more of the components may be aggregated and additional components performing functions described herein may be included in the analytic computing entity 65. Thus, the analytic computing entity 65 can be adapted to accommodate a variety of needs and circumstances.

b. Exemplary User Computing Entity

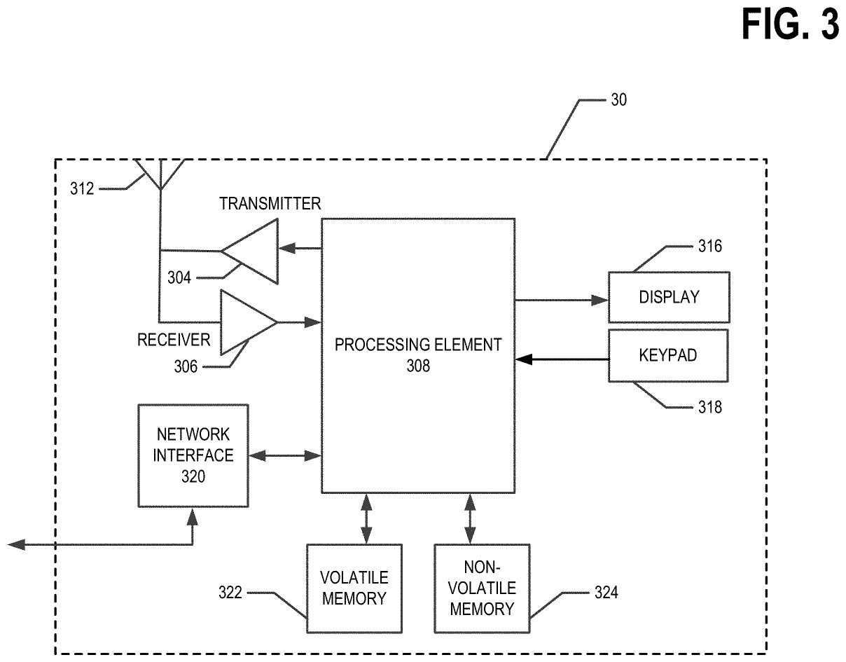

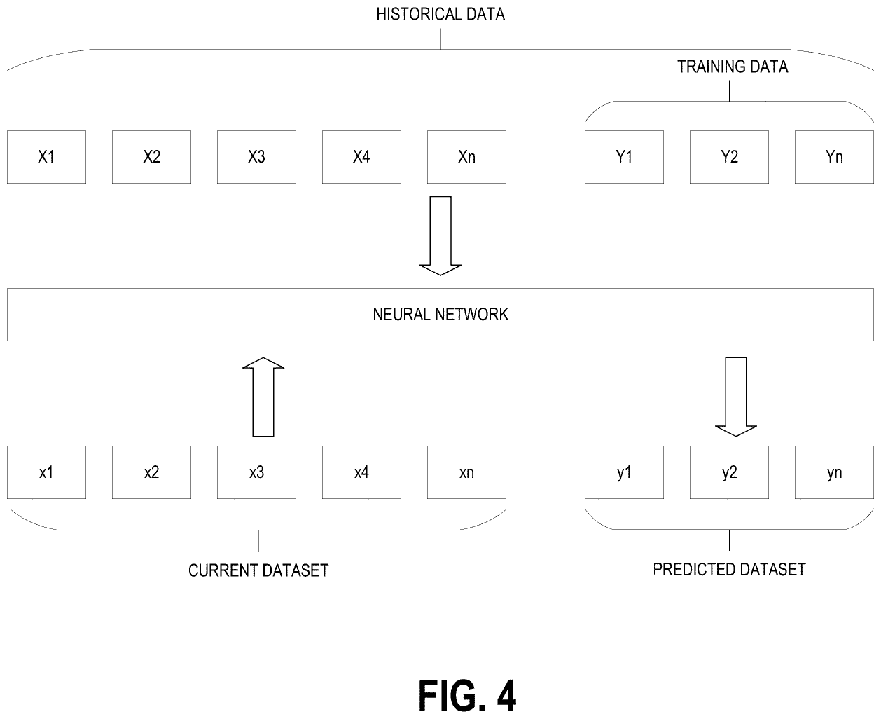

FIG. 3 provides an illustrative schematic representative of user computing entity 30 that can be used in conjunction with embodiments of the present invention. As will be recognized, the user computing entity may be operated by an agent and include components and features similar to those described in conjunction with the analytic computing entity 65. Further, as shown in FIG. 3, the user computing entity may include additional components and features. For example, the user computing entity 30 can include an antenna 312, a transmitter 304 (e.g., radio), a receiver 306 (e.g., radio), and a processing element 308 that provides signals to and receives signals from the transmitter 304 and receiver 306, respectively. The signals provided to and received from the transmitter 304 and the receiver 306, respectively, may include signaling information/data in accordance with an air interface standard of applicable wireless systems to communicate with various entities, such as an analytic computing entity 65, another user computing entity 30, and/or the like. In this regard, the user computing entity 30 may be capable of operating with one or more air interface standards, communication protocols, modulation types, and access types. More particularly, the user computing entity 30 may operate in accordance with any of a number of wireless communication standards and protocols. In a particular embodiment, the user computing entity 30 may operate in accordance with multiple wireless communication standards and protocols, such as GPRS, UMTS, CDMA2000, 1xRTT, WCDMA, TD-SCDMA, LTE, E-UTRAN, EVDO, HSPA, HSDPA, Wi-Fi, WiMAX, UWB, IR protocols, Bluetooth protocols, USB protocols, and/or any other wireless protocol.

Via these communication standards and protocols, the user computing entity 30 can communicate with various other entities using concepts such as Unstructured Supplementary Service data (USSD), Short Message Service (SMS), Multimedia Messaging Service (MMS), Dual-Tone Multi-Frequency Signaling (DTMF), and/or Subscriber Identity Module Dialer (SIM dialer). The user computing entity 30 can also download changes, add-ons, and updates, for instance, to its firmware, software (e.g., including executable instructions, applications, program modules), and operating system.

According to one embodiment, the user computing entity 30 may include location determining aspects, devices, modules, functionalities, and/or similar words used herein interchangeably. For example, the user computing entity 30 may include outdoor positioning aspects, such as a location module adapted to acquire, for example, latitude, longitude, altitude, geocode, course, direction, heading, speed, UTC, date, and/or various other information/data. In one embodiment, the location module can acquire data, sometimes known as ephemeris data, by identifying the number of satellites in view and the relative positions of those satellites. The satellites may be a variety of different satellites, including LEO satellite systems, DOD satellite systems, the European Union Galileo positioning systems, the Chinese Compass navigation systems, Indian Regional Navigational satellite systems, and/or the like. Alternatively, the location information/data/data may be determined by triangulating the position in connection with a variety of other systems, including cellular towers, Wi-Fi access points, and/or the like. Similarly, the user computing entity 30 may include indoor positioning aspects, such as a location module adapted to acquire, for example, latitude, longitude, altitude, geocode, course, direction, heading, speed, time, date, and/or various other information/data. Some of the indoor aspects may use various position or location technologies including RFID tags, indoor beacons or transmitters, Wi-Fi access points, cellular towers, nearby computing devices (e.g., smartphones, laptops) and/or the like. For instance, such technologies may include iBeacons, Gimbal proximity beacons, BLE transmitters, Near Field Communication (NFC) transmitters, and/or the like. These indoor positioning aspects can be used in a variety of settings to determine the location of someone or something to within inches or centimeters.

The user computing entity 30 may also comprise a user interface comprising one or more user input/output interfaces (e.g., a display 316 and/or speaker/speaker driver coupled to a processing element 308 and a touch screen, keyboard, mouse, and/or microphone coupled to a processing element 308). For example, the user output interface may be configured to provide an application, browser, user interface, dashboard, webpage, and/or similar words used herein interchangeably executing on and/or accessible via the user computing entity 30 to cause display or audible presentation of information/data and for user interaction therewith via one or more user input interfaces. The user output interface may be updated dynamically from communication with the analytic computing entity 65. The user input interface can comprise any of a number of devices allowing the user computing entity 30 to receive data, such as a keypad 318 (hard or soft), a touch display, voice/speech or motion interfaces, scanners, readers, or other input device. In embodiments including a keypad 318, the keypad 318 can include (or cause display of) the conventional numeric (0-9) and related keys (#, *), and other keys used for operating the user computing entity 30 and may include a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs the user computing entity 30 can collect information/data, user interaction/input, and/or the like.

The user computing entity 30 can also include volatile storage or memory 322 and/or non-volatile storage or memory 324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the user computing entity 30.

c. Exemplary Networks

In one embodiment, the networks 135 may include, but are not limited to, any one or a combination of different types of suitable communications networks such as, for example, cable networks, public networks (e.g., the Internet), private networks (e.g., frame-relay networks), wireless networks, cellular networks, telephone networks (e.g., a public switched telephone network), or any other suitable private and/or public networks. Further, the networks 135 may have any suitable communication range associated therewith and may include, for example, global networks (e.g., the Internet), MANs, WANs, LANs, or PANs. In addition, the networks 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, satellite communication mediums, or any combination thereof, as well as a variety of network devices and computing platforms provided by network providers or other entities.

### III. EXEMPLARY SYSTEM OPERATION

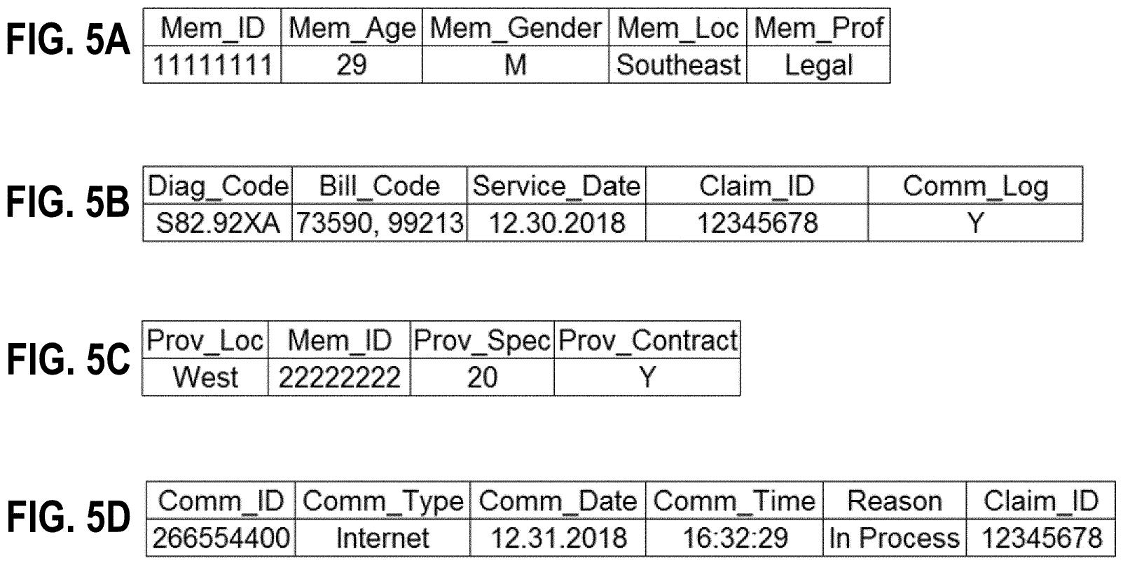

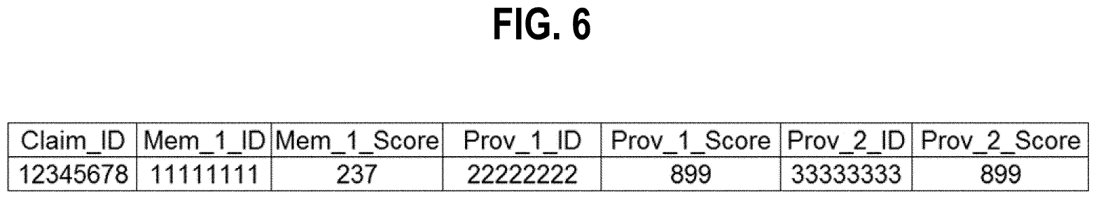

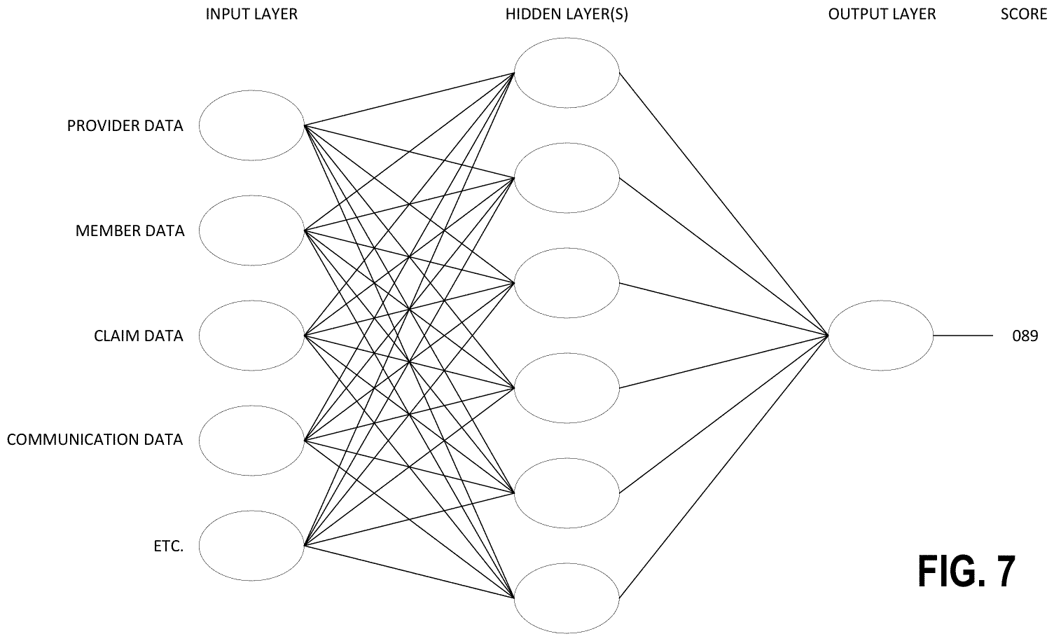

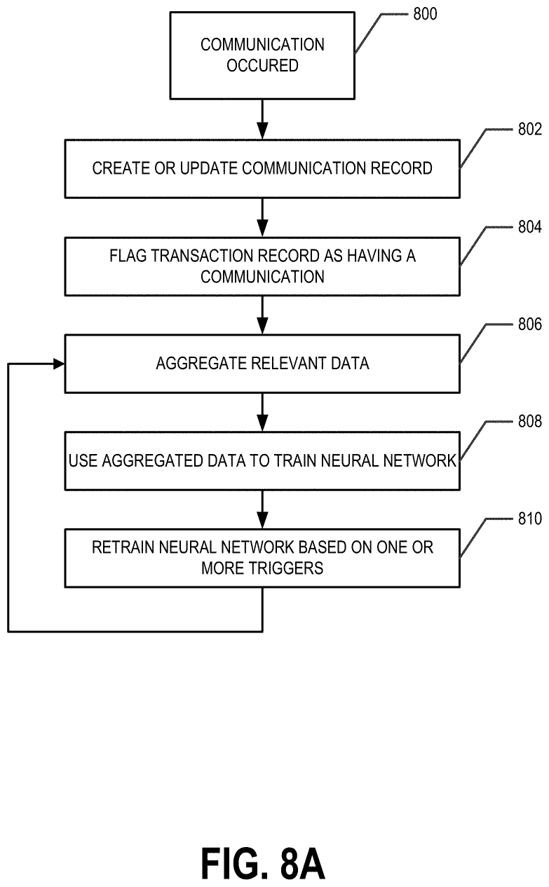

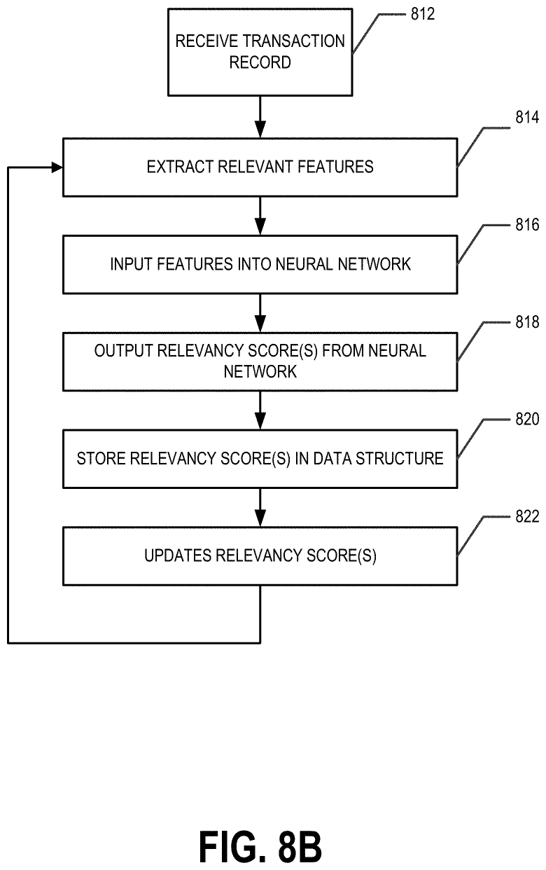

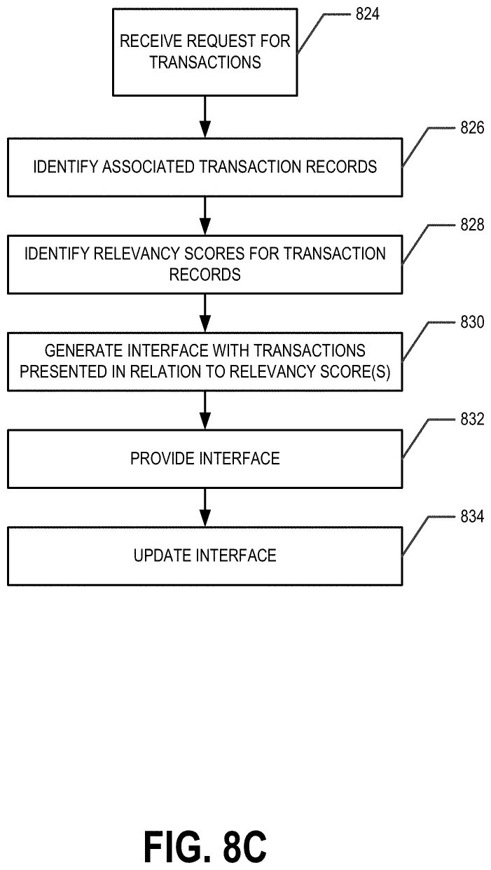

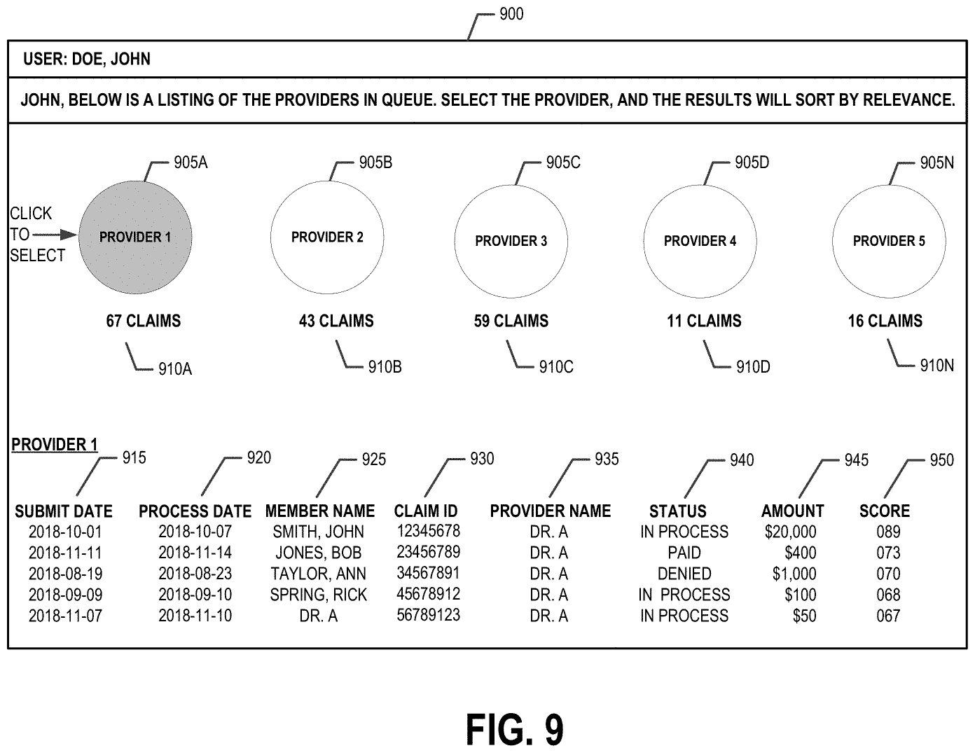

Reference will now be made to FIGS. 5A, 5B, 5C, 5D, 6, 7, 8A, 8B, 8C, and 9. FIGS. 5A-5D provide exemplary features and/or feature sets. FIG. 6 is an exemplary data structure storing predicted relevancy score information/data corresponding to a particular transaction, and FIG. 7 is an exemplary neural network that generates the predicted relevancy scores. FIGS. 8A, 8B, and 8C are flowcharts for exemplary operations, steps, and processes. And FIG. 9 provides and an interactive user interface that can be dynamically updated.

a. Brief Overview

As indicated, there is a latent need for a rigorous methodology that can automatically predict relevancy scores indicative of the predicted level of interest to a stakeholder (e.g., person or entity) and dynamically update a user interface regarding the same. For example, there are countless transactions that occur that relate to one or more stakeholders (e.g., persons or entities). In the healthcare context, there are more than 10 billion healthcare-related claims (e.g., transactions) that are submitted and processed in the United States each year. Current methodologies for predicting the relevance of each transaction and presenting the same to end users are inaccurate, inefficient, and resource-intensive. However, the disclosed approach uses machine learning (e.g., neural networks) to predict relevancy scores for one or more users for each transactions. The relevancy scores are predictions of the level of interest or importance to a given user. The relevancy scores at least take into account user information/data (e.g., provider information/data), transaction information/data (e.g., claim information/data), and communication information/data. It should be noted that while many of the examples are provided in the healthcare context, embodiments of the invention are not so limited; rather, these examples are provided to aid in understanding the various embodiments.

### 1. Technical Problem

A technical approach for predicting relevancy scores for transactions will help to customize interfaces for end users to present the most relevant transactions to users. This will eliminate or reduce the need for complex and resource-intensive search and provide for more user-friendly interfaces.

### 2. Technical Solution

To overcome at least the above-identified technical challenges, machine learning (e.g., neural networks) can be used in a continuously learning manner to predict relevancy scores for transactions (e.g., claims) using a unique approach for presentation via a dynamically updatable user interface. By using machine learning (e.g., neural networks), vast amounts of time-independent information/data and the time-dependent information/data can be continuously analyzed to predict relevancy sores for transactions (e.g., claims). This allows for solution that is easy to deploy, accurate, up-to-date, and computationally efficient. This disclosure describes a machine learning approach that can analyze vast amounts of information/data in a computational efficient manner to train one or more neural networks, use the one or more neural networks to predict relevancy scores and dynamically update a user interface.

b. Users and User Profiles

In one embodiment, a user (e.g., provider, member, insurance carrier employee or representative, and/or the like) may interact with and navigate a user interface 900 through a user computing entity 30. Through the user interface 900, the user (e.g., provider, member, insurance carrier employee or representative, and/or the like) may view and access transaction information/data, member information/data, provider information/data, communication information/data, and/or the like. To do so, the relevancy prediction system 100 may provide access to the system via a user profile that has been previously established and/or stored. In an example embodiment, a user profile comprises user profile information/data, such as a user identifier configured to uniquely identify the user (e.g., provider identifier, member identifier, and/or the like), a username, user contact information/data (e.g., name, one or more electronic addresses such as emails, instant message usernames, social media user name, and/or the like), user preferences, user account information/data, user credentials, information/data identifying one or more user computing entities 30 corresponding to the user, and/or the like. Moreover, each user and/or user profile may correspond to a username, unique user identifier (e.g., 11111111), access credentials, and/or the like.

With the user profile providing access to information/data through the user interface 900, the user can access and navigate the same.

c. Transaction Information/Data

As indicated, embodiments of the present invention can be used with a variety of transactions. In a particular embodiment, the transactions may be healthcare or other claims. In the healthcare context, a claim represents a request for payment/reimbursement for services rendered, materials used, equipment provided, and/or the like. For example, a claim may be a request for payment/reimbursement for a consultation with a primary care doctor, a medical procedure or an evaluation performed by an orthopedic surgeon, a laboratory test performed by a laboratory, a surgery, durable medical equipment provided to an injured patient, medications or other materials used in the treatment of a patient, and/or the like. As will be recognized, though, embodiments of the present invention are not limited to the medical context. Rather, they may be applied to a variety of other settings.

In one embodiment, each claim may be stored as a record that comprises a textual description of the type of claim to which the record corresponds and comprises member features, claim features, provider features, communication features, and/or the like. The various features and feature sets can be identified in a manual, semi-automatic, and/or automatic manner for identification and/or extraction for a given claim.

FIG. 5B provides exemplary transaction information/data or transaction features that can be associated with a given transaction (e.g., claim), member, provider, and/or communication. The terms information, data, features, and other terms are used herein interchangeably. The claims features may continuously change (e.g., be time-dependent) for many reasons, such as the prevalence of certain diseases, the emergence of new diseases (e.g., representing new claim), and/or previous medical codes being introduced and/or discontinued.

Example claim features may include a claim ID and the date a claim was received—e.g., Dec. 14, 2018, at 12:00:00 pm and time stamped as 2018-12-14 12:00:00. The claim features may also include one or more diagnostic codes, treatment codes, treatment modifier codes, and/or the like. Such codes may be any code, such as Current Procedural Terminology (CPT) codes, billing codes, Healthcare Common Procedure Coding System (HCPCS) codes, ICD-10-CM Medical Diagnosis Codes, and/or the like.

By way of example of billing codes, a patient may visit a doctor because of discomfort in his lower leg. During the visit, the doctor may examine the patient's lower leg and take an x-ray of the lower leg as part of an examination. The claim for the visit may have two distinct billing codes: billing code 99213 and billing code 73590. Billing code 99213 may be used to request payment/reimbursement for the visit, examination, and evaluation of the patient. Billing code 73590 may be used to request payment/reimbursement for the x-ray of the leg. Using such codes and code sets, various correlations can be determined as they related to recoverability. Each claim may have a state and status. The states may be original, pre-adjudicated, or post-adjudicated. The three states relate to where the claim is in the process of being reviewed with a corresponding determination being made as to the claim's status. In addition to a state, a claim may also have a status: paid, denied, in process, appealed, appeal denied, overpaid, and/or the like. In one embodiment, the relevancy prediction system 100 takes into account post-adjudicated claims.

From a process standpoint, once a claim is submitted, either through an online portal, through mail, one or more APIs, and/or the like, the health insurance company starts its review of the claim. Once the review is complete, the claim is either rejected, modified, or paid in full.

In terms of relevance, from a provider's perspective, the provider might be interested in a claim that did not fully pay out the procedures (e.g., high relevancy score relative to the provider). From a member's perspective, this might not be as important because he or she understands his or her benefits and what is covered (low relevancy score relative to the member) on the same claim. Thus, the relevance of a claim can be different based on the stakeholder. When an insurance company is contacted regarding a claim that was not paid in full, an appeal process might take place. Even at this point, the relevancy for each individual claim to a business function is relative to its stakeholders. A provider with hundreds of claims might take a small loss and not follow through with an appeal (low relevancy relative to the provider). As will be recognized, a variety of other approaches and techniques can be used with embodiments of the present invention.

FIG. 5A provides a subset of member information/data or member features that can be associated with a given member, provider, claim, and/or recovery. As used herein, the term member may refer to a person who receives healthcare services or products rendered by a provider and/or who relies on financing from a health insurance payer to cover the costs of the rendered health services or products. In that sense, a member is associated with the health insurance payer and is said to be a member of (a program associated with) the health insurance payer. In one embodiment, member features can include, but are not limited to, age, gender, poverty rates, known health conditions, home location, profession, access to medical care, medical history, claim history, member identifier, and/or the like.

FIG. 5C provides a subset of provider information/data or provider features that can be associated with a given member, provider, claim, and/or communication. A provider may refer to a person or entity that provides services or products. In at least one embodiment, in the health care context, providers rely on a health insurance payers to finance or reimburse the cost of the services or products provided. For example, a provider may comprise a health professional operating within one or more of a plurality of branches of healthcare, including medicine, surgery, dentistry, midwifery, pharmacy, psychology, psychiatry, pain management, nursing, laboratory diagnostics, and/or the like. A provider may also comprise an organization, such as a private company, hospital, laboratory, or the like, that operates within one or more of a plurality of branches of healthcare. Each provider may be associated with provider features that include, but not are not limited to, demographics (e.g., the location in which the provider operations), contracted status, specialty, and/or one or more relevancy scores for the provider. A relevancy score may identify the predicted level of interest or relevance to the provider.

Similar to claim features, provider features can continuously change (e.g., be time-dependent) for several reasons. For instance, within a given provider, the software, policies for submitting claims, personnel, strategies for submitting claims, experience, and/or the like may change in an unpredictable manner and result in a sudden change to the recoverability associated with that provider.

d. Communication Information/Data and Logging

In one embodiment, users (e.g., providers, members, insurance carrier employees or representatives, and/or the like) can review, access, inquire about, interact with, and/or the like with transaction information/data (e.g., claim information/data). For example, a user (e.g., provider, member, insurance carrier employee or representative, and/or the like) may navigate a user interface 900 by operating a user computing entity 30 to view and access transaction (e.g., claim) information/data, member information/data, provider information/data, communication information/data, and/or the like.

In one embodiment, the relevancy prediction system 100 (e.g., via an analytic computing entity 65) can track and store data (e.g., communication records) regarding communications for particular transactions, such as mail communications, phone communications, fax communications, internet communications, and/or the like (step/operation 800, 801 of FIG. 8A). For example, each time a user calls regarding a particular transaction or accesses the interface 900 and navigates to information/data associated with the transaction, the relevancy prediction system 100 (e.g., via an analytic computing entity 65) can record information/data associated with the communication and/or transaction. Then, the communications records can be used to form part of the training data for one or more neural networks or other machine learning aspects.

As shown in FIG. 5D, the relevancy prediction system 100 can create and/or update communication records that comprise communication information/data or communication features about the communication, transaction, provider, member, and/or the like (e.g., the transaction to which the communication relates). The communication information/data may include a communication identifier, a transaction identifier for the transaction of interest, member information/data (e.g., member identifier), the reason the transaction is of interest (e.g., denied, in process, appealed, appeal denied, and/or the like), the date of the communication, the form of the communication (e.g., fax, email, internet, mail, phone, and/or the like), the time of the communication, the result of the communication (e.g., resubmission), and/or the like.

In addition to creating and/or updating a communication record as a result of a communication (step/operation 802, 804 of FIG. 8A), the relevancy prediction system 100 can flag or provide an indication in the corresponding claim information/data (e.g., record) that a communication has occurred that relates to the transaction. Continuing with the above examples, the flag or indication is indicative that a communication has occurred related to the corresponding transaction (e.g., claim). FIG. 5B shows a binary label or indication of “Y” or “1” for yes or an “N” or “0” for no regarding whether a communication has occurred for this claim. Moreover, the claim identifier in the claim information/data (FIG. 5B) and the communication information/data (FIG. 5D) creates a connection from the claim to the communication and vice versa. This allows the relevancy prediction system 100 (e.g., via an analytic computing entity 65) to access and/or aggregate all communication records for a given transactions (e.g., claims) and/or or retrieve other relevant information/data.

As will be recognized, the member information/data or features, claim information/data or features, provider information/data or features, and communication information/data or features can be used to manually, semi-automatically, or automatically establish, update, and/or modify feature sets for training or retraining one or more neural networks. As will be recognized then, a feature set may comprise one or more features from the member features, claim features, provider features, communication features, and/or the like.

e. Data Aggregation

As indicated operation/step 806 of FIG. 8A, with one or more communication records corresponding to one or more claims, the relevancy prediction system 100 (e.g., via an analytic computing entity 65) can aggregate relevant information/data or features into a training dataset to train one or more neural networks. For example, with the claim records flagged as having a communication associated with the corresponding claims, in one embodiment, the relevancy prediction system 100 (e.g., via an analytic computing entity 65) can retrieve the information/data from the flagged claim records. In some embodiments, the relevancy prediction system 100 (e.g., via an analytic computing entity 65) can then filter the claims records of interest. This may include filtering the retrieved records to be of a particular type, within a date range, to satisfy freshness criteria (be relatively recent), be from certain regions, correspond to specific types of providers, and/or the like. This may allow for customized training of particular types of claims, providers, members, and/or the like. The relevancy prediction system 100 (e.g., via an analytic computing entity 65) can also retrieve provider information/data or features, member information/data or features, and/or communication information/data or features. For example, based on the transaction information/data (e.g., claim information/data), the relevancy prediction system 100 (e.g., via an analytic computing entity 65) can retrieve any desired information/data to form feature sets for training one or more neural networks.

f. Train Neural Network

As will be recognized, artificial neural networks are designed to recognize patterns using machine learning algorithms. Typically, the patterns they recognize are numerical, contained in vectors, into which real-world data is translated. With regard to embodiments of the present invention, the real world data may comprise provider information/data, member information/data, transaction information/data, and/or communication information/data. The desired features of the relevant information/data are extracted and formatted into multidimensional vectors to be input into one or more neural networks. The neural networks comprise one or more layers for that receive, amplify or dampen the input, and provide an output. For multiple layers, each layer's output is simultaneously the subsequent layer's input. With regard to predicting a relevancy score for a given claim, the neural network assigns a numerical weight to a healthcare claim with the purpose of “measuring” the importance of the claim to a particular stakeholder. The predicted relevancy score can vary based on a variety of factors.

As will be recognized, training and/or retraining a neural network involves providing a training dataset to the neural network (steps/operations 808, 810 of FIG. 8A). The training dataset contains the target output or variable (e.g., the relevancy score) that the machine-learning model is to eventually predict along with the related features. The neural network detects patterns in the training dataset that map the input information/data attributes from the feature sets to the target output or variable and captures these patterns. The resulting neural network is then able to generate predictions for new or unseen transaction information/data for which the target is unknown. The predictions can be determined in real-time—such as when a new claim is received as having been adjudicated. By performing real-time predictions, a user interface for a given user (e.g., provider, member, insurance carrier employee or representative, and/or the like) can also be updated dynamically to provide the most up-to-date and prioritized claim information/data.

As a result of the training or retraining, one or more neural networks are generated to subsequently predict relevancy scores of unseen transactions (e.g., claims). For instance, using the neural network, the relevancy prediction system 100 (e.g., via an analytic computing entity 65) generates one or more predicted relevancy scores for unseen transactions (e.g., claims).

In one embodiment, the relevancy prediction system 100 (e.g., via an analytic computing entity 65) can retrain the neural network on a regular or continuous basis or in response to certain triggers. This may be necessary because claim features and influencing factors can vary over time. In one embodiment, the relevancy prediction system 100 (e.g., via an analytic computing entity 65) may retrain a neural network when actions occur for a claims (e.g., being denied, paid, accessed, appealed, and/or the like) on a regular basis.

As will be appreciated, the hidden and/or weak correlations found as a result of the neural network are simply not practical for human-implementation. In addition to outputting predicted relevancy scores of unseen transactions (e.g., claims), the neural networks can be retrained on a continuous, regular, or triggered basis.

g. Predicting Relevancy Scores using Neural Network

As indicated by step/operation 812 of FIG. 8B, with one more neural networks trained, the relevancy prediction system 100 (e.g., via an analytic computing entity 65) can use the one or more neural networks to generate predicted relevancy scores for unseen transactions (e.g., claims). As indicated steps/operations 812, 814, when a transaction (e.g., claim) is received, the relevancy prediction system 100 (e.g., via an analytic computing entity 65) can extract the relevant features of the claim. This may include retrieving additional information/data about members, providers, communications, and/or the like associated with the claim. This may also include formatting the features into a multidimensional vector for input into one or more neural networks.

The features can then be input into the neural network (e.g., step/operation 818 of FIG. 8B). The neural network (e.g., via an analytic computing entity 65) can then output one or more relevancy scores for the transaction (e.g., claim) and processing. For example, the one or more neural networks can predict relevancy scores for each provider associated with a transaction (e.g., claim), each member associated with the transaction (e.g., claim), each entity (e.g., insurance company) associated with the transaction (e.g., claim), and/or the like.

In various embodiments, predicting a relevance score for a transaction (e.g., claim) can be implemented using a variety of approaches. For example, claims can be scored in real-time as they are received (individually or in batch). Thus, responsive to the relevancy prediction system 100 (e.g., via an analytic computing entity 65) receiving one or more unseen transactions (e.g., claims), the relevancy prediction system 100 (e.g., via an analytic computing entity 65) can score (e.g., generate a predicted relevancy score for) the one or more unseen transactions (e.g., claims). The predicted relevancy score may be in the domain of [000,100]. In this example, the higher the output integer, the higher the relevance the claim has to a particular stakeholder. Similarly, the lower the output integer, the lower the relevance the claim has to a particular stakeholder.

The predicted relevancy scores can be stored in a relevancy score data structure intended for the same (step/operation 820 of FIG. 8B), such as NoSQL structures and/or the like.For example, FIG. 6 provides an exemplary data structure for a claim. The data structure is identifiable by the claim identifier, one or more provider identifiers, and/or one or more member identifiers. This particular relevancy score data structure comprises three relevancy scores: one for the member, one for a first provider, and one for a second provider. This relevancy score data structure can be linked or connected to the transaction (e.g., claim), member, or provider). Table 1 below lists exemplary relevancy scores output by a neural network.

TABLE 1
Predicted Recovery Rates/Scores

23456789: 073
56789123: 067
34567891: 070
45678912: 068
12345678: 089

As will be recognized, because claims features are highly dynamic and change continuously during a given time period, claim scoring can occur in a similar manner.

As will be recognized, predicted relevancy scores can be updated and vary based on time (step/operation 822 of FIG. 8B). For example, a transactions relevance may decrease over time. Accordingly, the relevancy prediction system 100 (e.g., via an analytic computing entity 65) can update relevancy scores on a regular or continuous basis or in response to certain triggers. This may be necessary because claims can lose relevance over time (e.g., the older they are) or as the result of particular actions (e.g., a claim being paid). Thus, the relevancy prediction system 100 (e.g., via an analytic computing entity 65) may update relevancy scores every month or two months or when an action occurred for a claims (e.g., being denied, paid, accessed, appealed, and/or the like). Other exemplary triggers may include action on a claim, inaction on a claim within a configurable time period (e.g., 30 days), adjudication actions, changes to claims processing rules, claims that require preauthorization, and/or the like. As will be recognized, a variety of approaches and techniques can be used to adapt to various needs and circumstances.

Additionally, the relevancy scoring will also allow for in-depth reviews of transactions (e.g., claims), members, providers, communications, and/or the like. For example, this may allow for determinations of when and why certain provider specialty codes call insurance companies, identification of rejection codes in claims that are relevant to certain provider specialties, identification or rejection codes in claims that are relevant to provider geographical locations, payment discrepancies more relevant to provider specialty codes, and/or the like. Similarly, it will allow for the overlay of data to understand members are affected by the transaction process. Members behave differently than providers and insurance companies. By aggregating their behavior into models, more accurate predictions of claim relevancy can be made.

h. Dynamically Update User Interface

As indicated above, the relevancy prediction system 100 can provide access for viewing, investigating, and/or navigating via a user interface 900 being displayed by a user computing entity 30. Thus, the user interface 900 can be dynamically updated to show the claims associated with the user sorted in relevance order (step/operation 824 of FIG. 8C). To do so, the relevancy prediction system 100 accesses the claims associated with the user based on the user's access credentials (step/operation 826 of FIG. 8C). The relevancy prediction system 100 can also retrieve the predicted relevancy scores corresponding to the claim for the user (step/operation 828 of FIG. 8C).

With the relevant transaction information/data (e.g., claim information/data), the relevancy prediction system 100 can sort the transactions (e.g., claims) in descending or ascending order. In one embodiment, the transactions (e.g., claims) are ordered in a descending manner so the most relevant claims are provided to the user. As will be recognized, a variety of other approaches and techniques can be used to adapt to various needs and circumstances. For example, the relevancy prediction system 100 (e.g., via an analytic computing entity 65) may continuously determine predicted relevancy scores for unseen transactions (e.g., claims), continuously update the interface based on newly scored transactions (e.g., claims), and/or the like.

As shown via the user interface 900 of FIG. 9 and steps/operations 830, 832, 834, the user interface may comprise various features and functionality for accessing, viewing, investigating, and/or navigating transactions (e.g., claims). In one embodiment, the user interface 900 may identify the user (e.g., provider, member, insurance carrier employee or representative, and/or the like) credentialed for currently accessing the user interface 900 (e.g., John Doe). The user interface 900 may also comprise messages to the user in the form of banners, headers, notifications, and/or the like.

In one embodiment, the user interface 900 may display one or more member elements 905A-905N, member elements 905A-905N, provider elements 905A-905N, and/or the like. The present example provides five separate provider elements 905A-905N that, when selected, cause the most relevant claims for the provider to be displayed. The terms elements, indicators, graphics, icons, images, buttons, selectors, and/or the like are used herein interchangeably. In one embodiment, each element 905A-905N may only represent claims that satisfy a threshold, such as being greater than 050 in their predicted relevancy. In yet another embodiment, the elements 905A-905N may comprise represent all claims for the user (e.g., provider, member, insurance carrier representative). In one embodiment, each element 905A-905N may be selected to control what the user interface 900 displays as the information/data in elements 915, 920, 925, 930, 935, 940, 945, 950, and/or the like. For example, if element 905A is selected via a user computing entity 30 (for provider 1), elements 915, 920, 925, 930, 935, 940, 945, and 950 are dynamically populated with information/data corresponding to claims for “PROVIDER 1.”

In one embodiment, each element 905A-905N may further be associated with elements 910A-910N. The elements 910A-910N may be selected via the user computing entity 30 to control how the user interface 900 sorts and displays the information/data in elements 915, 920, 925, 930, 935, 940, 945, 950, and/or the like.

In one embodiment, element 915 may represent the transaction (e.g., claim) submission date), and element 920 may represent the transaction (e.g., claim) process date. Selection of these elements may sort the claims based on the corresponding information. Elements 925 and 930 may be selectable elements for sorting and represent member names and claim identifiers for claims that were submitted, processed, and/or flagged. Element 935 may be selectable for sorting and represent the provide name corresponding to the claim. Elements 940, 945, and 950 may be selectable for sorting and represent the status of the claim, the amount of the claim, and the relevancy score of the claim. As will be recognized, the described elements are provided for illustrative purposes and are not to be construed as limiting the dynamically updatable interface in any way. As indicated above, the user interface 900 can be dynamically updated to show the most current priority order of claims at an inventory level, a queue level, and/or the like.

### VI. CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A computer-implemented method for dynamically updating a user interface, the method comprising:
storing, by one or more processors, a communication record corresponding to a communication for a first transaction, the first communication record comprising first communication data;
storing, by the one or more processors, an indication with a first transaction record for the first transaction, the indication indicating that a first communication has occurred for the first transaction, the first transaction record comprising first transaction data;
aggregating, by the one or more processors, a set of training data to train one or more artificial neural networks, the training data comprising at least a portion of the first communication data and at least a portion of the first communication data;
after training the neural network, receiving, by the one or more processors, a second transaction record, the second transaction record corresponding to a second transaction and comprising second transaction data;
determining, by the one or more processors, a first predicted relevancy score for the second transaction record using the one or more artificial neural networks, the first predicted relevancy score indicative of the predicted relevance to a first user;
determining, by the one or more processors, a second predicted relevancy score for the second transaction record using the one or more artificial neural networks, the second predicted relevancy score indicative of the predicted relevance to a second user;
storing, by the one or more processors, the first predicted relevancy score and the second predicted relevancy score in a data structure; and
dynamically providing, by the one or more processors, a user interface for display of at least a portion of the second transaction data in association with the first predicted relevancy score or the second predicted relevancy score.

2. The computer-implemented method of claim 1 further comprising:
responsive to a configurable time period of inaction elapsing, updating the first predicted relevancy score, the second predicted relevancy score, or both.

3. The computer-implemented method of claim 1 further comprising:
responsive to detection of an action occurring related to the second transaction, updating the first predicted relevancy score, the second predicted relevancy score, or both.

4. The computer-implemented method of claim 1 further comprising:
training the one or more neural networks based at least in part on the set of training data.

5. The computer-implemented method of claim 1 further comprising:
dynamically pushing an update to the user interface.

6. The computer-implemented method of claim 1 further comprising:
determining a predicted relevancy score for each of the first plurality of claims.

7. A computer program product comprising a non-transitory computer readable medium having computer program instructions stored therein, the computer program instructions when executed by a processor, cause the processor to:
store a communication record corresponding to a communication for a first transaction, the first communication record comprising first communication data;
store an indication with a first transaction record for the first transaction, the indication indicating that a first communication has occurred for the first transaction, the first transaction record comprising first transaction data;
aggregate a set of training data to train one or more artificial neural networks, the training data comprising at least a portion of the first communication data and at least a portion of the first communication data;
after training the neural network, receive a second transaction record, the second transaction record corresponding to a second transaction and comprising second transaction data;
determine a first predicted relevancy score for the second transaction record using the one or more artificial neural networks, the first predicted relevancy score indicative of the predicted relevance to a first user;
determine a second predicted relevancy score for the second transaction record using the one or more artificial neural networks, the second predicted relevancy score indicative of the predicted relevance to a second user;
store the first predicted relevancy score and the second predicted relevancy score in a data structure; and
dynamically provide a user interface for display of at least a portion of the second transaction data in association with the first predicted relevancy score or the second predicted relevancy score.

8. The computer program product of claim 7, wherein the computer program instructions are further configured to, when executed by a processor, cause the processor to:
responsive to a configurable time period of inaction elapsing, updating the first predicted relevancy score, the second predicted relevancy score, or both.

9. The computer program product of claim 7, wherein the computer program instructions are further configured to, when executed by a processor, cause the processor to:
responsive to detection of an action occurring related to the second transaction, updating the first predicted relevancy score, the second predicted relevancy score, or both.

10. The computer program product of claim 7 , wherein the computer program instructions are further configured to, when executed by a processor, cause the processor to:
train the one or more neural networks based at least in part on the set of training data.

11. The computer program product of claim 7, wherein the computer program instructions are further configured to, when executed by a processor, cause the processor to:
dynamically push an update to the user interface.

12. The computer program product of claim 7, wherein the computer program instructions are further configured to, when executed by a processor, cause the processor to:
determine a predicted relevancy score for each of the first plurality of claims.

13. A computing system comprising a non-transitory computer readable storage medium and one or more processors, the computing system configured to:
store a communication record corresponding to a communication for a first transaction, the first communication record comprising first communication data;
store an indication with a first transaction record for the first transaction, the indication indicating that a first communication has occurred for the first transaction, the first transaction record comprising first transaction data;
aggregate a set of training data to train one or more artificial neural networks, the training data comprising at least a portion of the first communication data and at least a portion of the first communication data;
after training the neural network, receive a second transaction record, the second transaction record corresponding to a second transaction and comprising second transaction data;
determine a first predicted relevancy score for the second transaction record using the one or more artificial neural networks, the first predicted relevancy score indicative of the predicted relevance to a first user;
determine a second predicted relevancy score for the second transaction record using the one or more artificial neural networks, the second predicted relevancy score indicative of the predicted relevance to a second user;
store the first predicted relevancy score and the second predicted relevancy score in a data structure; and
dynamically provide a user interface for display of at least a portion of the second transaction data in association with the first predicted relevancy score or the second predicted relevancy score.

14. The computing system of claim 13, wherein the computing system is further configured to:
responsive to a configurable time period of inaction elapsing, updating the first predicted relevancy score, the second predicted relevancy score, or both.

15. The computing system of claim 13, wherein the computing system is further configured to:
responsive to detection of an action occurring related to the second transaction, updating the first predicted relevancy score, the second predicted relevancy score, or both.

16. The computing system of claim 13, wherein the computing system is further configured to:
train the one or more neural networks based at least in part on the set of training data.

17. The computing system of claim 13, wherein the computing system is further configured to:
dynamically push an update to the user interface.

18. The computing system of claim 13, wherein the computing system is further configured to:
determine a predicted relevancy score for each of the first plurality of claims.
